(19) United States
(12) Patent Application Publication
(10) Pub. No.: US 2014/0190678 A1
(43) Pub. Date: Jul. 10, 2014

(54) PERSONALIZED VEHICLE CLIMATE CONTROL

(71) Applicant: FORD GLOBAL TECHNOLOGIES, LLC, Dearborn, MI (US)

(72) Inventors: Gary A. Dage, Franklin, MI (US); Michael T. Spencer, Canton, MI (US)

(21) Appl. No.: 13/735,136

(22) Filed: Jan. 7, 2013

(51) Int. Cl. B60H 1/00

(52) U.S. Cl. CPC B60H 1/00971; B60H 1/00828
USPC 165/202

(57) ABSTRACT

A climate control system includes a blower, a memory device, a user interface device, and a processor. The memory device stores a default value associated with a speed of the blower. The user interface device receives a user input changing the speed of the blower. The processor is in communication with the memory device, the user interface device, and the blower and controls the speed of the blower based at least in part on the default value. The processor determines whether a user input changing the speed of the blower has been received. In response to receiving the user input, the processor defines an adjusted control value based on the user input to replace the default value.

### BACKGROUND

Vehicles have a climate control system to control the cabin temperature for passenger comfort. The climate control system can quickly heat or cool the vehicle cabin by running the blower at a maximum speed. Doing so can generate too much noise for some passengers. Vehicle climate control systems seek to balance passenger comfort (i.e., maintaining the passenger compartment at a particular temperature) with acceptable noise, vibration, and harshness (NVH) levels.

### SUMMARY

A climate control system includes a blower, a memory device configured to store a default value associated with a speed of the blower, and a user interface device configured to receive a user input changing the speed of the blower. A processor is in communication with the memory device, the user interface device, and the blower, and the processor is configured to control the speed of the blower based, at least in part, on the default value stored in the memory device, determine whether a user input changing the speed of the blower has been received, and in response to receiving the user input, define an adjusted control value based on the user input to replace the default value.

A method includes accessing, from a memory device, a default value associated with a speed of a blower; controlling the speed of the blower based at least in part on the default value; receiving a user input changing the speed of the blower; and in response to receiving the user input, defining, via a computing device, an adjusted control value based on the user input to replace the default value.

A non-transitory computer-readable medium tangibly embodying computer-executable instructions that include accessing, from a memory device, a default value associated with a speed of a blower; controlling the speed of the blower based at least in part on the default value; determining whether a user input changing the speed of the blower has been received; and in response to receiving the user input, defining an adjusted control value based on the user input to replace the default value.

### BRIEF DESCRIPTION OF THE DRAWINGS

FIG. 1 illustrates an exemplary vehicle having a climate control system.

FIG. 2 illustrates exemplary components of the climate control system of FIG. 1.

FIG. 3 is a chart of exemplary voltage signals output by the climate control system of FIGS. 1 and 2 to cool the vehicle.

FIG. 4 is a chart of exemplary voltage signals output by the climate control system of FIGS. 1 and 2 to heat the vehicle.

FIG. 5 illustrates a flowchart of an exemplary process implemented by the climate control system of FIGS. 1 and 2.

### DETAILED DESCRIPTION

A climate control system includes a blower, a memory device, a user interface device, and a processor. The memory device stores a default value associated with a speed of the blower. The user interface device receives a user input changing the speed of the blower. The processor is in communication with the memory device, the user interface device, and the blower and controls the speed of the blower based at least in part on the default value. The processor determines whether a user input changing the speed of the blower has been received. In response to receiving the user input, the processor defines an adjusted control value based on the user input to replace the default value. Therefore, if a passenger finds that the blower is too loud or is otherwise unhappy with the speed of the blower, the climate control system will consider the passenger's preferred blower speed in the future.

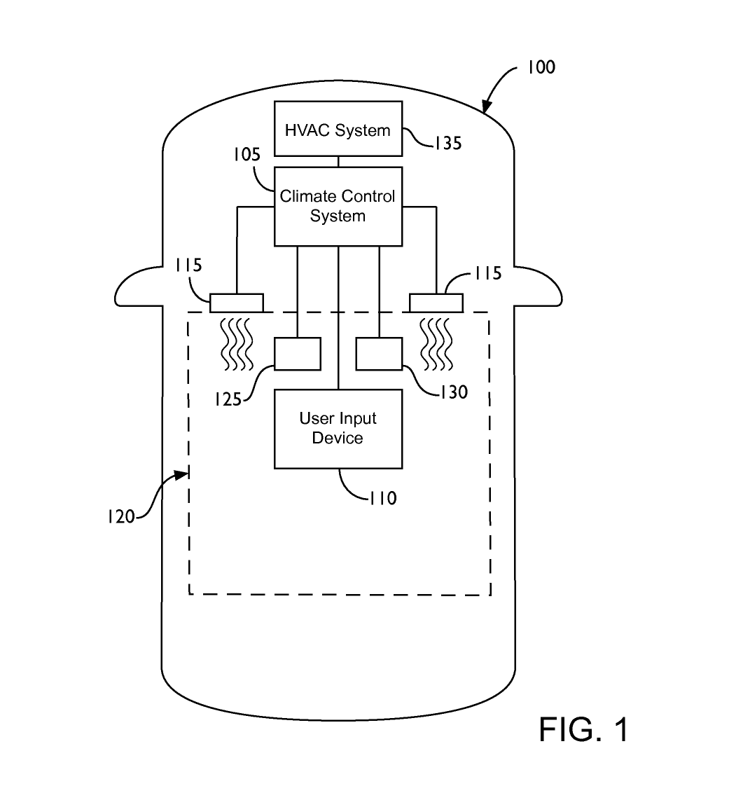

FIG. 1 illustrates an exemplary vehicle having a personalized climate control system. The system may take many different forms and include multiple and/or alternate components and facilities. While an exemplary vehicle and system are shown in the Figures, the exemplary components illustrated in the Figures are not intended to be limiting. Indeed, additional or alternative components and/or implementations may be used.

As illustrated in FIG. 1, a vehicle 100 includes a climate control system 105, a user input device 110, and blowers 115.

The vehicle 100 may include a mode of transportation such as a car, truck, airplane, or train. The vehicle 100 may include a passenger compartment 120, which may also be referred to as a cabin. The passenger compartment 120 may be defined as an area of the vehicle 100 where people can sit or otherwise gather while, e.g., the vehicle 100 is moving. The passenger compartment 120 may generally protect people from the elements and is therefore an enclosed part of the vehicle 100. Further, the passenger compartment 120 may be insulated. Thus, the climate inside the passenger compartment 120 may be different from the climate outside the vehicle 100.

The climate control system 105 may include any number of components configured to control aspects of the climate, such as the temperature, of the passenger compartment 120. For example, the climate control system 105 may be configured to heat or cool the passenger compartment 120 to a predetermined temperature based on various inputs. One possible input may include a temperature signal generated by a temperature sensor 125 configured to measure the temperature of the ambient air in the passenger compartment 120, outside the vehicle 100, or both. In one possible approach, the temperature sensor 125 may be located in the passenger compartment 120 of the vehicle 100. Another possible input may include a sun load signal generated by a sun load sensor 130. The vehicle 100 may include windows that allow sunlight into the passenger compartment 120, and the sun load represents the amount of sunlight to which one or more passengers are exposed. The sun load sensor 130 may be located on a vehicle 100 dashboard near, e.g., the windshield of the vehicle 100, and may estimate the sun load and output the sun load signal representing the estimated sun load. In one possible implementation, the sun load signal may quantify the sun load using relative percentages. For instance, a sun load of 100% may represent the amount of sunlight experienced by a passenger on a clear day at a time of the day when the intensity of the sun is at its highest. That is, the sun load may be 100% on a sunny day at noon at a location near the equator. A sun load of 0% may represent the amount of sunlight experienced by a passenger at night.

The climate control system 105 may use the signals generated by the temperature sensor 125 and the sun load sensor 130, among others, to control the climate of the passenger compartment 120. In one possible implementation, the climate control system 105 may be configured to generate various output signals to control the climate in the passenger compartment 120. One example signal may control a speed of one or more of the blowers 115. Another example signal may cause one or more of the blowers 115 to operate in different modes, such as an “automatic” mode and a “manual” mode.

In “automatic” mode, the climate control system 105 may be configured to automatically control the speed of the blowers 115 and the temperature of the air entering the passenger compartment 120 through the blowers 115. The “automatic” mode may be subdivided into different stages, such as an initial stage, a ramp stage, and a steady-state stage. During the initial stage, the climate control system 105 heats or cools the ambient air in the passenger compartment 120 by operating the blowers 115 at a relatively high speed. One way to operate the blowers 115 at a high speed during the initial stage is to provide the blowers 115 with a relatively high voltage. During the ramp stage, the climate control system 105 may steadily reduce the speed of the blowers 115 by reducing the voltage provided to the blowers 115. During the steady-state stage, the climate control system 105 maintains the air temperature by outputting a relatively low constant voltage to the blowers 115, causing the blowers 115 to operate at a lower speed than in the initial stage. In “manual” mode, the climate control system 105 may allow the user to manually control the speed of the blowers 115, the temperature of the air entering the passenger compartment 120 through the blowers 115, or both.

The climate control system 105 may be configured to generate one or more air temperature signals to control the air temperature provided to the blowers 115. The air temperature signals may be output to one or more components of a heating, ventilation, and air conditioning (HVAC) system 135 in the vehicle 100. The components may include a compressor configured to cool the air entering the passenger compartment 120 or a heater configured to heat the air entering the passenger compartment 120. Ducts may be used to transport the heated or cooled air to the blowers 115.

The user input device 110 may include any number of components located in the passenger compartment 120 and configured to allow a user, such as a driver or other passenger, to interact with the climate control system 105. The user input device 110 may be configured to receive various inputs from the user. Example user inputs may include a temperature setting, a blower speed setting, a mode selection, or the like. The temperature setting may allow the user to define the desired temperature of the passenger compartment 120. The blower speed setting may allow the user to increase or decrease the speed of the blower 115. The mode selection may allow the user to place the climate control system 105 in “automatic” mode or “manual” mode. The user input device 110 may include any number of buttons. Alternatively, the user input device 110 may include a touch-sensitive display screen configured to present virtual buttons to the user and receive user inputs via the virtual buttons.

The blowers 115 may include any device, such as one or more electrically operated fans, configured to push air into the passenger compartment 120. The blowers 115 may be controlled to rotate at a particular speed by, e.g., providing the blower 115 with a particular voltage, referred to as the operating voltage. That is, the speed of the blower 115 may be directly proportional to the operating voltage, which may be determined by the climate control system 105 or may be based on a user input received via the user input device 110. As the blower 115 rotates, air from the HVAC system 135 is pushed into the passenger compartment 120. For the sake of clarity, only two blowers 115 are shown in FIG. 1 and the ducts that carry air from the HVAC system 135 to the blowers 115 are omitted.

The climate control system 105 may allow the user to decide whether to use different blower speeds in the future, especially while the climate control system 105 is operating in “automatic” mode. For instance, the user may have turned down the blower speed because the user received a phone call. Otherwise, the user may have been happy with the blower speed. In this instance, the user may decline to have the climate control system 105 use the different blower speed in the future. Further, the climate control system may automatically reduce the blower speed when the user receives a phone call to accommodate the user's preferences. The climate control system 105 may communicate with other vehicle systems, such as a Bluetooth®-enabled system, to determine when the user is on the phone. To implement personalized control while in “manual” mode, the climate control system 105 may, for a given temperature and sun load, initially apply the blowers 115 at speeds consistent with previous user selections made under similar conditions, at least until the blower speed is changed by the user.

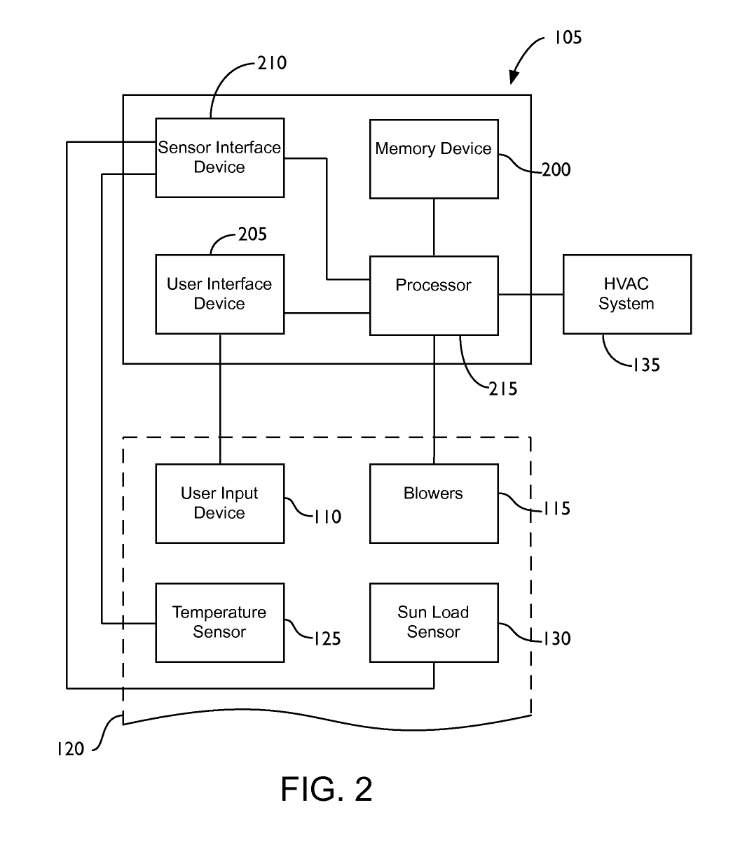

FIG. 2 illustrates exemplary components of the climate control system 105 of FIG. 1. The climate control system 105, as illustrated, includes a memory device 200, a user interface device 205, a sensor interface device 210, and a processor 215.

The memory device 200 may include any volatile or non-volatile memory storage device configured to store one or more data types representing information used to control the climate control system 105. The information stored in the memory device 200 may include one or more default values, each representing an operating voltage of the blower 115. A different default value may be associated with each operating stage of the “automatic” mode of the climate control system 105. For instance, one default value may be associated with the initial stage, another default value may be associated with the steady-state stage, and at least one other value may be associated with the ramp stage. The default values associated with the initial stage and the steady-state stage may represent constant voltages while default values associated with the ramp stage may define a rate at which to reduce the operating voltage between the initial stage and the steady-state stage. The default values may be stored in one or more tables or databases.

The memory device 200 may further store adjusted control values stored in one or more tables or databases. The adjusted control values may be determined by the processor 215 as discussed below. Like the default values, each adjusted control value may represent an operating voltage for each operating stage in “automatic” mode of the climate control system 105. In one possible implementation, the adjusted control value may include the default value adjusted by a predetermined adjustment margin based on, e.g., the user input. Because the adjusted control values consider user inputs, controlling the blowers 115 with the adjusted control values instead of the default values provides personalized “automatic” control of the blowers 115 while the climate control system 105 is in “automatic” mode.

In one possible implementation, the climate control system 105 may apply different profiles, each associated with a different driver, to personalize the blower speed. The profile applied may be determined from a user selection via, e.g., a human machine interface in the vehicle or from a key or fob used to unlock, access, or start the vehicle. Whether the default values or adjusted control values are applied may be based on the applied profile. Changes made to the default value may be profile-specific so the preferences of one driver will not change the default values for another driver. The default values and adjusted control values for each profile may be stored in one or more tables or databases in the memory device 200.

The user interface device 205 may be configured to interface with the user input device 110 in the passenger compartment 120 to receive the user inputs. One type of user input may represent a user's desire to change the speed of the blower 115 while the climate control system 105 is operating in “automatic” mode. Other types of user inputs received may represent a user's desire to place the climate control system 105 in “manual” mode, change the air temperature, etc.

The sensor interface device 210 may be configured to allow the climate control system 105 to interface with different types of sensors located in the passenger compartment 120 or elsewhere in the vehicle 100. The sensor interface device 210 may be configured to receive the temperature signal generated by the temperature sensor 125 and the sun load signal generated by the sun load sensor 130. The sensor interface device 210 may be configured to generate signals based on the temperature signal and sun load signal and output generated signals to the processor 215.

The processor 215 may be in communication with the memory device 200, the user interface device 205, and the sensor interface device 210 and may include any computing device configured to execute computer-readable instructions. In one possible implementation, the processor 215 may be configured to output one or more control signals to the blowers 115 located in the passenger compartment 120. Further, the processor 215 may be configured to determine whether the climate control system 105 is in “automatic” mode or “manual” mode. If in “manual” mode, the processor 215 may be configured to output signals to control the blower 115 in accordance with user inputs associated with the speed of the blower 115 and the desired temperature of the ambient air. If in “automatic” mode, the processor 215 may be configured to determine the present operating stage, access the memory device 200 for the default value or values associated with the operating stage, and control the speed of the blower 115 according to the default values, at least until a user input is received.

The processor 215 may be configured to selectively control the blowers 115 to operate in any of the operating stages by outputting the appropriate signal in accordance with a default value. For instance, to operate the blowers 115 during the initial stage, the processor 215 may output a first signal having a first operating voltage based on a first default value. During the steady-state stage, the processor 215 may output a second signal having a second operating voltage in accordance with a second default value. The first operating voltage may be higher than the second operating voltage so that the blowers 115 will spin faster during the initial stage than in the steady-state stage. A different default value may be used to control the blowers 115 during the ramp stage. During the ramp stage, the processor 215 may be configured to steadily reduce the output voltage provided to the blowers 115 to gradually reduce the speed of the blower 115 from the speeds at the initial stage to the speed at the steady-state stage.

The processor 215 may be configured to detect a user input indicating the user's desire to change the speed of the blower 115. The processor 215 may detect the user input based on a signal received from the user interface device 205. In response to receiving the user input changing the speed of the blower 115, the processor 215 may define the adjusted control value, based on the user input, to replace the default value. That is, the processor 215 may be configured to output the adjusted control value instead of the default value to control the blowers 115 in accordance with the user input. The processor 215 may be further configured to determine whether to store the adjusted control value in the memory device 200. For example. the adjusted control value may represent the user's preference for the speed of the blowers 115 when the climate control system 105 is operating in “automatic” mode. The processor 215 may use the adjusted control value instead of the default value to control the speed of the blowers 115 in the future. To make the adjusted control value available for future use, the processor 215 may store the adjusted control value in the memory device 200. One way to determine whether the user prefers the blower 115 provided with the adjusted control value over the default value is to ask the user. The processor 215 may be configured to cause the user interface device 205 to prompt the user, via the user input device 110, to indicate whether he or she would prefer that the adjusted control value be used instead of the default value.

The processor 215 may be configured to associate the adjusted control value with particular circumstances that existed at the time the user provided the user input. The processor 215 may be configured to use the adjusted control value instead of the default value in similar circumstances in the future. The circumstances may include the ambient air temperature in the passenger compartment 120, the sun load, the temperature outside the vehicle 100, or the like. For instance, the processor 215 may select a different default value or adjusted control value for each temperature range, sun load range, or combination thereof. By way of example only, the processor 215 may be configured to use the adjusted control value when the temperature is between 80-90 degrees Fahrenheit with a sun load of 90% because those are the circumstances under which the user provided the input. Continuing with this example, if the temperature is between 70-80 degrees Fahrenheit with a sun load of 90%, the processor 215 may continue to use the default value.

As with the default values, the processor 215 may be configured to selectively control the blowers 115 using one or more adjusted control values. The processor 215 may generate and output a signal having a voltage based on a first adjusted control value during the initial stage and a second adjusted control value during the steady-state stage. The first adjusted control value may call for a higher voltage than the second adjusted control value. A different adjusted control value may be used during the ramp stage to gradually reduce the speed of the blower 115 between the initial stage and the steady-state stage.

Alternatively or in addition, the processor 215 may be configured to selectively control the blowers 115 using a combination of default values and adjusted control values. For instance, a default value may be used during one stage while an adjusted control value is used during another stage. This may occur if the user provides a user input indicating the user's desire to change the speed of the blower 115 during only one stage. Indeed, the processor 215 may be configured to use the default values during the stage or stages where no user input was received.

The processor 215 may be configured to determine the operating voltage represented by the adjusted control value. In one possible approach, the adjusted control value may be based on an adjustment margin, which may represent a voltage, such as 0.5 volts, to be added to or subtracted from the default value. Using the adjustment margin, the processor 215 may increase or reduce the default value in, e.g., 0.5 volt increments to define the adjusted control value. The processor 215 may be configured to apply the adjustment margin each time the user input changing the speed of the blower 115 is received. Thus, if three user inputs reducing the speed of the blower 115 are received, the adjusted control value may be 1.5 volts lower than the default value.

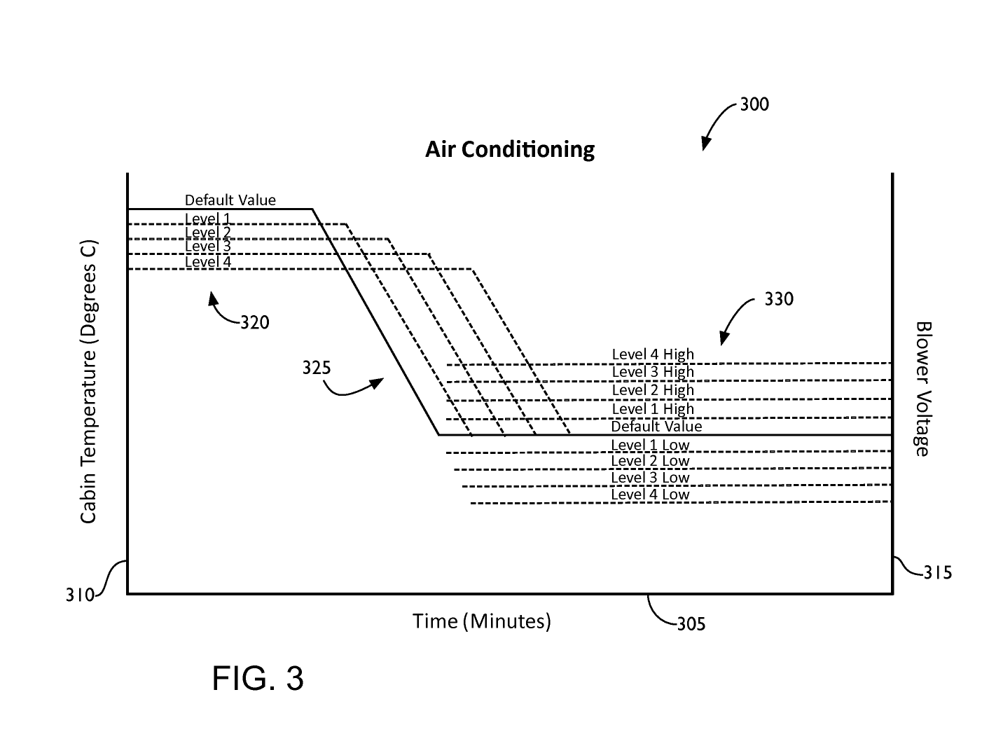

FIG. 3 is a chart 300 of exemplary voltage signals output by the processor 215 to cool the passenger compartment 120 to a predetermined temperature. These voltage signals may be generated by the processor 215 to control the blowers 115 when the climate control system 105 is in the “automatic” mode and attempting to cool the passenger compartment 120 over a predetermined amount of time. The chart includes an X-axis 305 and two Y-axes 305, 310. The X-axis 305 represents time and the left Y-axis 310 represents cabin temperature, which may be the temperature inside the passenger compartment 120 of the vehicle 100. The right Y-axis 315 may represent the output voltage provided to the blower 115.

The chart 300 shows the output voltages at the initial stage 320, the ramp stage 325, and the steady-state stage 330. The line labeled “Default Value” shows how the output voltage changes in accordance with the cabin temperature over time when the blower 115 is controlled in accordance with the default values. The dashed lines each represent the effects of different adjusted control values at each stage. During the initial stage 320, the processor 215 may output a relatively high voltage to the blower 115 in accordance with the default value. A relatively high voltage indicates that the blower 115 will spin at a relatively high speed. If the user finds that the blower 115 is too loud, the user may provide a user input to lower the speed of the blower 115. The processor 215 may reduce the voltage output to the blower 115 by the adjustment margin, which may be approximately 0.5 volts, to define the first adjusted control value. The voltage associated with the first adjusted control value for the initial stage 320 is represented by the dashed line labeled “Level 1” in the chart 300. If the blower 115 is still too loud, the user may provide a further user input to reduce the first adjusted control value by the adjustment margin to define the second adjusted control value, represented as “Level 2” in the chart 300. The user can continue to adjust the output voltage to the blower 115 to other levels as well (i.e., “Level 3” and “Level 4”). A limit may be placed on the lowest possible output voltage during the initial stage 320. For example, the processor 215 may not allow the user to reduce the output voltage to a level lower than that represented by the line labeled “Level 4.” Each reduction of the output voltage to the blower 115 may increase the amount of time of the initial stage 320 because reducing the output voltage causes the blower 115 to slow down. Therefore, it may take more time to cool the passenger compartment 120. Moreover, the user may provide a user input to increase the speed of the blower 115. The processor 215 may increment the present output voltage by the adjustment margin up to and including the default level or possibly higher. Increasing the speed of the blower 115 may decrease the length of the initial stage 320.

The processor 215 may transition to the ramp stage 325 after a certain amount of time or as the passenger compartment 120 begins to cool. During the ramp stage 325, the processor 215 may gradually reduce the output voltage to steadily reduce the speed of the blower 115. The default value applied during the ramp stage 325 may define the rate at which the output voltage is gradually reduced. The rate at which the output voltage is reduced may change in accordance with the user input. That is, the user input may increase or decrease the rate at which the output voltage is reduced.

When operating in the steady-state stage 330, which may occur when the passenger compartment 120 is cooled to the predetermined temperature, the processor 215 may provide the output voltage to the blower 115 in accordance with the default value. If the blower 115 is too loud to the user in the steady-state stage 330, the speed of the blower 115 may be decreased via the user input to the output voltages represented by the lines “Level 1 Low,” “Level 2 Low,” “Level 3 Low,” or “Level 4 Low,” which represent adjusted control values. If the user prefers a higher speed of the blower 115 than provided by the default value in the steady-state stage 330, the processor 215 may increase the speed of the blower 115 in response to a user input. The processor 215 may generate output voltages as represented by the lines “Level 1 High,” “Level 2 High,” “Level 3 High,” or “Level 4 High” to increase the speed of the blower 115 above the default level. These levels represent adjusted control values. The processor 215 may automatically use one or more of the adjusted control values instead of the default values in the initial stage 320, the ramp stage 325, and the steady-state stage 330 to implement the user's previous selections made via the user input device 110. As discussed above, the processor 215 may only use the adjusted control value if the circumstances (e.g., temperature, sun load, etc.) are the same as or similar to when the user provided the user input.

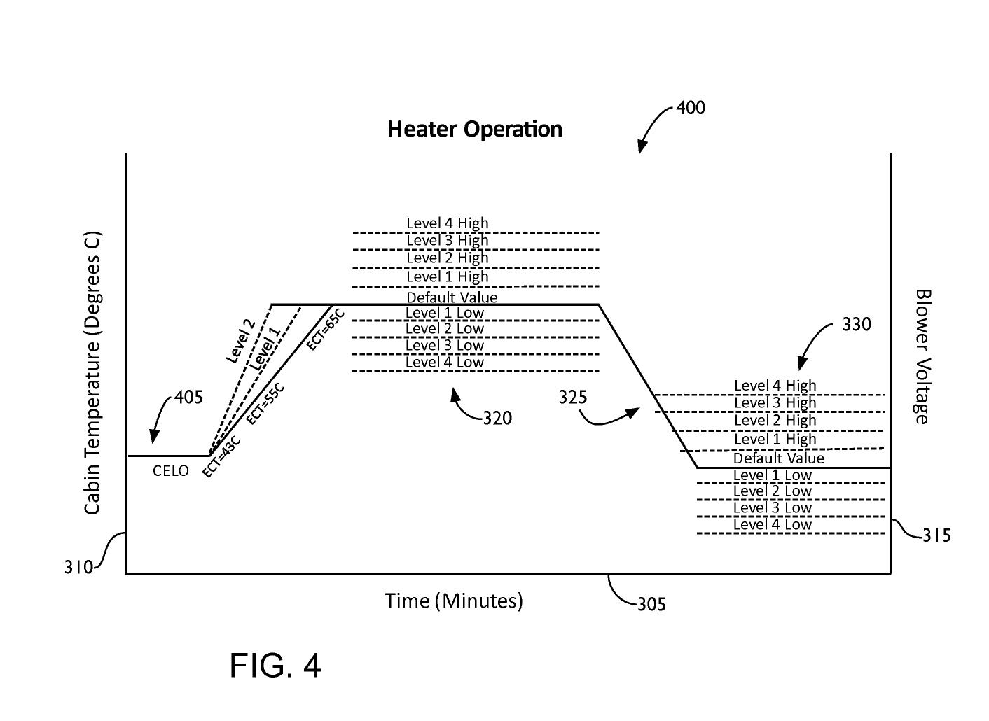

FIG. 4 is a chart 400 of exemplary voltage signals that may be output by the climate control system 105 to heat the passenger compartment 120 of the vehicle 100. The chart 400 is similar to the chart 300 in that the chart 400 includes the initial stage 320, the ramp stage 325, and the steady-state stage 330 along with default values and potential adjusted control values at each stage. The chart 400 further includes a start-up voltage 405 associated with a cold engine lockout (CELO) temperature. The CELO temperature may be the minimum temperature of the engine needed to heat the air provided to the passenger compartment 120. The processor 215 may be configured to apply the start-up voltage 405 prior to the initial stage 320 and may ramp the voltage provided to the blower 115 from the start-up voltage 405 to that of the initial stage 320. The rate at which the voltage is increased may be based upon a default value that causes the voltage to increase in accordance with an increase in engine temperature, which may be determined from an engine coolant temperature (ECT) sensor (not shown). As illustrated in the chart 400, the voltage is increased as the ECT sensor outputs example values of 43 degrees Celsius, 55 degrees Celsius, and 65 degrees Celsius. The processor 215 may change the rate at which the start-up voltage 405 is increased to the voltage applied during the initial stage 320 based on a user input received via the user input device 110. The dashed lines labeled “Level 1” and “Level 2” before the initial stage 320 represent example adjusted control values that may represent the rate at which the voltage increases between the start-up voltage 405 and the initial stage 320. The processor 215 may be configured to store these and any other adjusted control values in the memory device 200 for future use instead of the default value.

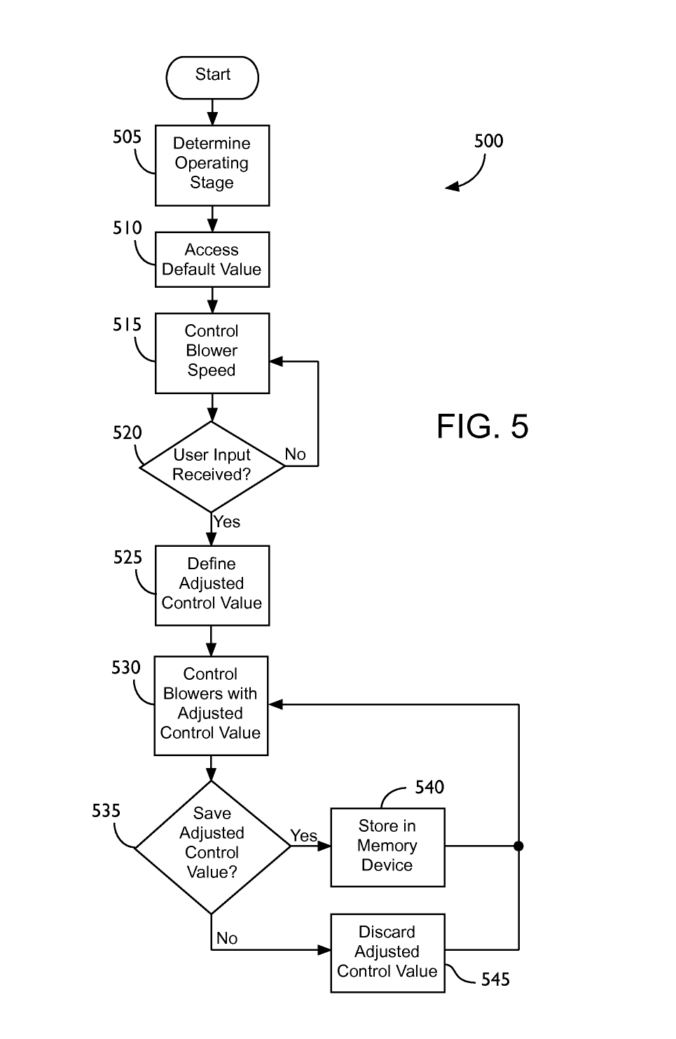

FIG. 5 illustrates a flowchart of an exemplary process 500 that may be implemented by the climate control system 105, and in particular, the processor 215. The process 500 may be implemented when the climate control system 105 is in “automatic” mode as opposed to “manual” mode.

At block 505, the processor 215 may determine an operating stage of the blower 115. As illustrated in FIGS. 3 and 4, the output voltage applied to the blower 115 depends upon the operating stage. Example operating stages include the initial stage 320, the ramp stage 325, and the steady-state stage 330. Other possible operating stages may occur before the initial stage 320, such as when the start-up voltage 405 is applied and when the voltage is increased from the start-up voltage 405 to the voltage applied during the initial stage 320, as discussed with respect to FIG. 4. In addition to determining the operating stage, the processor 215 may further identify various conditions, such as the temperature of the air inside the passenger compartment 120, the temperature outside the vehicle 100, the sun load, etc.

At block 510, the processor 215 may access the default value from the memory device 200. As discussed above, the default value is associated with the speed of the blower 115, and a different default value may be used for each operating stage of the blower 115. Thus, the processor 215 may consider the operating stage determined at block 505 when accessing the default value. A first default value may be selected from the memory device 200 if the blower 115 is operating in the initial stage 320 while a second default value may be selected from the memory device 200 if the blower 115 is operating in a later stage, such as the ramp stage 325 or the steady-state stage 330. The default value accessed from the memory device 200 may depend upon various circumstances, such as the temperature of the passenger compartment 120 and the sun load. The temperature of the passenger compartment 120 may be determined from the temperature signal output by the temperature sensor 125. The sun load may be determined from the sun load signal output by the sun load sensor 130. For purposes of simplicity, the following discussion assumes that the processor 215 accesses the default value. If the processor 215 has previously determined and saved an adjusted control value in the memory device 200 (see blocks 525 and 540, below), however, the processor 215 may access the adjusted control value from the memory device 200 instead of the default value at block 510. Moreover, whether a previously defined adjusted control value or the default value is accessed may be based on the various conditions identified at block 510.

At block 515, the processor 215 may control the speed of the blower 115 in accordance with the default value, which as discussed above may represent an operating voltage. The processor 215 may use the default value to output the appropriate operating voltage for the operating stage determined at block 505 in view of the default value accessed from the memory device 200 at block 510. In response, the blower 115 may spin at a speed designated by the default value. By controlling the speed of the blower 115 in this manner, the processor 215 can selectively control the blower 115 to operate in any of the operating stages. For instance, when provided with the operating voltage associated with a first default value, the blower 115 may spin at the speed associated with the initial stage 320. When provided with the operating voltage associated with a second default value, the blower 115 may spin at the speed associated with a later stage, such as the ramp stage 325 or the steady-state stage 330.

At decision block 520, the processor 215 may determine whether a user input indicating the user's preference to change the speed of the blower 115 was received. The user may provide the user input if, e.g., the user finds that the blower 115 is too loud or is not changing the temperature of the passenger compartment 120 fast enough. When the user input is received, the process 500 may continue at block 525. If no user input is received, the process 500 may continue to control the blowers 115 in accordance with the default value as indicated at block 515 until the user input is received.

At block 525, the processor 215 may define an adjusted control value based on the user input received at block 520. Because the adjusted control value may be used in place of the default value to control the speed of the blower 115, a different adjusted control value may be defined for each operating stage in which the user input is received. Accordingly, a first adjusted control value may be defined if the user input is received during the initial stage 320 and a second adjusted control value may be defined if the user input is received during a later stage, such as the ramp stage 325 or the steady-state stage 330. The adjusted control value may be defined from the default value modified according to an adjustment margin based on the user input. For instance, if the adjustment margin represents an increase or decrease of 0.5 volts, the adjusted control value may be the operating voltage represented by the default value increased or decreased by 0.5 volts. Therefore, the adjusted control value may be higher than the default voltage if the user input increases the speed of the blower 115 and lower than the default voltage if the user input decreases the speed of the blower 115.

At block 530, the processor 215 may control the blowers 115 in accordance with the adjusted control value instead of the default value. The processor 215 may provide the operating voltage associated with the adjusted control value to the blowers 115, and in response, the speed of the blowers 115 may change in accordance with the operating voltage provided. The processor 215 may continue to control the blowers 115 in this manner until the blower 115 moves to the next stage (e.g., the ramp stage 325 or the steady-state stage 330), the climate control system 105 exits “automatic” mode, or the vehicle 100 is turned off, for example.

At decision block 535, the processor 215 may determine whether to store the adjusted control value in the memory device 200. This decision may be based on a user preference. Therefore, the processor 215 may cause the user input device 110 to prompt the user to decide whether to save the adjusted control value. If the user responds affirmatively, the process 500 may continue at block 540. If not, the process 500 may continue at block 545.

At block 540, the processor 215 may store the adjusted control value in the memory device 200 so the processor 215 can access the adjusted control value in the future to control the speed of the blowers 115. The processor 215 may control the speed of the blowers 115 using the adjusted control value saved in the memory device 200 instead of the default value. The processor 215 may further associate the adjusted control value with the circumstances (i.e., outside air temperature, air temperature of the passenger compartment 120, sun load, etc.) at the time the user input at block 520 was received. These circumstances may be associated with the adjusted control value in the memory device 200 so that they may be applied in similar circumstances.

At block 545, the processor 215 may continue to control the speed of the blower 115 in accordance with the adjusted control values but discard the adjusted control values as soon as the blower 115 moves to the next stage (e.g., the ramp stage 325 or the steady-state stage 330), the climate control system 105 exits “automatic” mode, or the vehicle 100 is turned off, for example.

In general, computing systems and/or devices, such as the processor and the user input device, may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., and the Android operating system developed by the Open Handset Alliance.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

1. A method comprising:
accessing, from a memory device, a default value associated with a speed of a blower;
controlling the speed of the blower based at least in part on the default value;
receiving a user input changing the speed of the blower; and
in response to receiving the user input, defining, via a computing device, an adjusted control value based on the user input to replace the default value.

2. The method of claim 1, further comprising determining whether to store the adjusted control value in the memory device, and if so, storing the adjusted control value in the memory device.

3. The method of claim 1, wherein the default value and adjusted control value are each associated with an operating voltage of the blower, and wherein controlling the speed of the blower includes controlling the speed of the blower in accordance with the operating voltage.

4. The method of claim 1, further comprising determining an operating stage of the blower.

5. The method of claim 1, wherein accessing the default value includes a first default value associated with first stage of the blower and a second default value associated with a second stage of the blower, and wherein controlling the speed of the blower includes selectively controlling the blower to operate in at least one of a first stage in accordance with the first default value and the second stage in accordance with the second default value.

6. The method of claim 5, wherein the adjusted control value includes a first adjusted control value and a second adjusted control value, and wherein defining the adjusted control value includes:
defining the first adjusted control value in response to receiving the user input while the blower is in the first stage, and
defining the second adjusted control value in response to receiving the user input while the blower is operating in the second stage.

7. The method of claim 5, wherein the first stage includes at least one of an initial stage and a ramp stage, and wherein the second stage includes at least one of the ramp stage and a steady-state stage.

8. The method of claim 1, wherein the user input includes an adjustment margin, and wherein defining the adjusted control value includes defining the adjusted control value based on the default value modified by the adjustment margin.

9. A climate control system comprising:
a blower;
a memory device configured to store a default value associated with a speed of the blower;
a user interface device configured to receive a user input changing the speed of the blower;
a processor in communication with the memory device, the user interface device, and the blower, wherein the processor is configured to control the speed of the blower based at least in part on the default value stored in the memory device, determine whether a user input changing the speed of the blower has been received, and in response to receiving the user input, define an adjusted control value based on the user input to replace the default value.

10. The climate control system of claim 9, wherein the processor is configured to determine whether to store the adjusted control value in the memory device.

11. The climate control system of claim 9, wherein the default value and adjusted control value are each associated with an operating voltage of the blower, and wherein the speed of the blower is controlled in accordance with the operating voltage.

12. The climate control system of claim 9, wherein the default value stored in the memory device includes a first default value and a second default value, and wherein the processor is configured to selectively control the blower to operate in in at least a first stage in accordance with the first default value and a second stage in accordance with the second default value.

13. The climate control system of claim 12, wherein the adjusted control value includes a first adjusted control value and a second adjusted control value, and wherein the processor is configured to define the first adjusted control value in response to receiving the user input while the blower is in the first stage and the second adjusted control value in response to receiving the user input while the blower is in the second stage.

14. The climate control system of claim 12, wherein the first stage includes at least one of an initial stage and a ramp stage, and wherein the second stage includes at least one of the ramp stage and a steady-state stage.

15. The climate control system of claim 9, wherein the user input includes an adjustment margin, and wherein the processor is configured to define the adjusted control value based on the default value modified by the adjustment margin.

16. A non-transitory computer-readable medium tangibly embodying computer-executable instructions comprising:
accessing, from a memory device, a default value associated with a speed of a blower;
controlling the speed of the blower based at least in part on the default value;
determining whether a user input changing the speed of the blower has been received; and
in response to receiving the user input, defining an adjusted control value based on the user input to replace the default value.

17. The non-transitory computer-readable medium of claim 16, the instructions further comprising determining an operating stage of the blower.

18. The non-transitory computer-readable medium of claim 16, wherein accessing the default value includes a first default value associated with first stage of the blower and a second default value associated with a second stage of the blower, and wherein controlling the speed of the blower includes selectively controlling the blower to operate in at least one of a first stage in accordance with the first default value and the second stage in accordance with the second default value.

19. The non-transitory computer-readable medium of claim 16, wherein the adjusted control value includes a first adjusted control value and a second adjusted control value, and wherein defining the adjusted control value includes:
defining the first adjusted control value in response to receiving the user input while the blower is in the first stage, and
defining the second adjusted control value in response to receiving the user input while the blower is operating in the second stage.

20. The non-transitory computer-readable medium of claim 16, wherein the user input includes an adjustment margin, and wherein defining the adjusted control value includes defining the adjusted control value based on the default value modified by the adjustment margin.
